(19) United States
(12) Patent Application Publication
(10) Pub. No.: US 2026/0195080 A1
(43) Pub. Date: Jul. 9, 2026

(54) STORAGE MEDIUM STORING APPLICATION PROGRAM CAPABLE OF EXECUTING PRINTING FUNCTION PROVIDED IN EACH IMAGE FORMING APPARATUS WITHOUT CAUSING EXCESS OR DEFICIENCY REGARDLESS OF WHETHER LOCATION OF INFORMATION PROCESSING APPARATUS IS THE SAME AS LOCATION OF EACH IMAGE FORMING APPARATUS, CONTROL METHOD FOR INFORMATION PROCESSING APPARATUS, AND INFORMATION PROCESSING APPARATUS

(71) Applicant: CANON KABUSHIKI KAISHA, Tokyo (JP)

(72) Inventor: MASARU ITO, Kanagawa (JP)

(21) Appl. No.: 19/430,436

(22) Filed: Dec. 23, 2025

(30) Foreign Application Priority Data
Jan. 6, 2025 (JP) 2025-001664

(51) Int. Cl. G06F 3/12

(52) U.S. Cl. CPC G06F 3/1228; G06F 3/1205; G06F 3/1237

(57) ABSTRACT

A non-transitory computer-readable storage medium storing an application program installed on an information processing apparatus communicably connected to a plurality of image forming apparatuses having a printing function and a management server managing information about each of the image forming apparatuses is provided. A printer driver controlling execution of the printing function in each of the image forming apparatuses is installed on the information processing apparatus. The application program causes a computer of the information processing apparatus to execute a step of determining whether or not at least one of the plurality of image forming apparatuses belongs to a location of the information processing apparatus, and a step of selecting one of the plurality of image forming apparatuses as a printing executing apparatus that executes the printing function, and reflecting the printing function provided in the printing executing apparatus in a function capable of being controlled by the printer driver.

### BACKGROUND

### Field of the Technology

The present disclosure relates to a storage medium storing an application program, a control method for an information processing apparatus, and an information processing apparatus.

### Description of the Related Art

An image forming system, which includes a plurality of information processing apparatuses such as personal computers and a plurality of image forming apparatuses such as multi-function peripherals (MFPs), has been known. In this image forming system, one information processing apparatus is capable of instructing any one image forming apparatus from among the plurality of image forming apparatuses to perform printing. Hereinafter, this type of printing will be referred to as “arbitrary apparatus printing”. The arbitrary apparatus printing is made possible by a management server included in the image forming system managing information about print jobs. In addition, in order to improve security and print processing capacity in the image forming system, the arbitrary apparatus printing has a function of restricting the image forming apparatuses to a certain group. For example, in the case of an image forming system that includes a plurality of information processing apparatuses and a plurality of image forming apparatuses, which are located within the same business establishment, there is a “location function” that enables the arbitrary apparatus printing. The location function enables the arbitrary apparatus printing by grouping a plurality of information processing apparatuses and a plurality of image forming apparatuses into the same location by using, for example, a specific range of IP addresses or host names.

For example, Japanese Laid-Open Patent Publication (kokai) No. 2021-18675 discloses a configuration in which, for each location, a management server manages network information, and information about printing functions of image forming apparatuses that belong to the location. In the configuration disclosed in Japanese Laid-Open Patent Publication (kokai) No. 2021-18675, in the case where a notification that network settings have been changed has been received from an information processing apparatuses, the location of the information processing apparatuses is identified. Furthermore, by transmitting a device setting of a printer driver that is based on the information about the printing function of the image forming apparatus to the information processing apparatus, even in the case where the location of the information processing apparatus has been moved, printing according to the functions (capabilities) of the image forming apparatuses included in a location after movement becomes possible.

However, in the configuration disclosed in Japanese Laid-Open Patent Publication (kokai) No. 2021-18675, although the arbitrary apparatus printing is capable of being performed, in the case where an image forming apparatus with a stapling function and an image forming apparatus without a stapling function exist in the same location (belong to the same affiliation) in the image forming system, the following phenomenon will occur. That is, in the case where a user wants to output stapled printed matter (stapled printouts), the user sets the stapling function by the printer driver and should select the image forming apparatus with the stapling function, but the user ends up selecting the image forming apparatus without the stapling function, and as a result, the stapled printouts will not be output.

### SUMMARY

The present disclosure provides a storage medium storing an application program capable of executing a printing function provided in each image forming apparatus without causing excess or deficiency regardless of whether a location of an information processing apparatus is the same as a location of the each image forming apparatus or not. In addition, the present disclosure provides a control method for an information processing apparatus and an information processing apparatus that are capable of executing the printing function provided in the each image forming apparatus without causing excess or deficiency regardless of whether the location of the information processing apparatus is the same as the location of the each image forming apparatus or not.

Accordingly, a first aspect of the present disclosure provides a non-transitory computer-readable storage medium storing an application program installed on an information processing apparatus communicably connected to a plurality of image forming apparatuses having a printing function and a management server that manages information about each of the image forming apparatuses, wherein a printer driver that controls execution of the printing function in each of the image forming apparatuses has been installed on the information processing apparatus, and the application program causes a computer of the information processing apparatus to execute a determining step of determining whether or not at least one image forming apparatus from among the plurality of image forming apparatuses belongs to a location of the information processing apparatus, and a reflecting step of selecting one image forming apparatus included in the plurality of image forming apparatuses as a printing executing apparatus that causes to execute the printing function, and reflecting the printing function provided in the printing executing apparatus in a function capable of being controlled by the printer driver.

Accordingly, a second aspect of the present disclosure provides an information processing apparatus communicably connected to a plurality of image forming apparatuses having a printing function and a management server that manages information about each of the image forming apparatuses, wherein a printer driver that controls execution of the printing function in each of the image forming apparatuses, and an application program have been installed on the information processing apparatus, and the application program causes a computer of the information processing apparatus to execute a determining step of determining whether or not at least one image forming apparatus from among the plurality of image forming apparatuses belongs to a location of the information processing apparatus, and a reflecting step of selecting one image forming apparatus included in the plurality of image forming apparatuses as a printing executing apparatus that causes to execute the printing function, and reflecting the printing function provided in the printing executing apparatus in a function capable of being controlled by the printer driver.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram that illustrates an example of an overall configuration of an image forming system.

FIG. 2 is a block diagram that illustrates an example of a hardware configuration of an MFP.

FIG. 3 is a block diagram that illustrates an example of a hardware configuration of a PC.

FIG. 4 is a block diagram that illustrates an example of a hardware configuration of a management server.

FIG. 5A and FIG. 5B are a sequence diagram that illustrates processing executed among the MFP, the management server, and the PC.

FIG. 6 is a flowchart that illustrates a processing executed by a resident application.

FIG. 7 is a flowchart that illustrates a detailed processing performed in a step S213 of the flowchart shown in FIG. 6.

FIG. 8A is a diagram that illustrates an example of a screen displayed by the resident application.

FIG. 8B is a diagram that illustrates an example of a screen displayed by the resident application.

FIG. 8C is a diagram that illustrates a modification of the screen shown in FIG. 8B.

FIG. 8D is a diagram that illustrates an example of a screen displayed by the resident application.

FIG. 9 is a flowchart that illustrates a processing (a notification screen display processing for notifying an operation status of the MFP) executed by the resident application.

FIG. 10A and FIG. 10B are diagrams that illustrate examples of screens before and after a printing function reflection processing.

### DESCRIPTION OF THE EMBODIMENTS

The present disclosure will now be described in detail below with reference to the accompanying drawings showing embodiments thereof.

Hereinafter, an embodiment of the present disclosure will be described in detail with reference to the drawings. However, the configuration described in the embodiment below is merely an example, and the scope of the present disclosure is not limited by the configuration described in the embodiment. For example, each unit (each component) constituting the present disclosure can be replaced with a unit (a component) with any configuration that can perform the same function(s). In addition, any component(s) may be added.

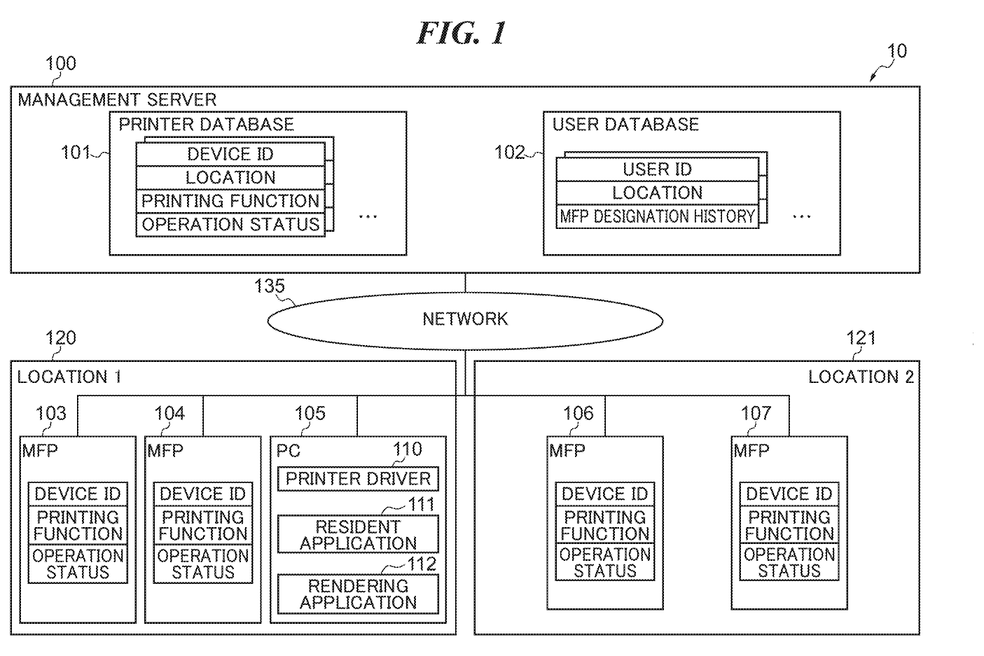

FIG. 1 is a block diagram that illustrates an example of an overall configuration of an image forming system. As shown in FIG. 1, an image forming system 10 includes a management server 100, a multi-function peripheral (an MFP) 103, an MFP 104, a personal computer (a PC) 105, an MFP 106, and an MFP 107. These apparatuses (the management server 100, the MFP 103, the MFP 104, the PC 105, the MFP 106, and the MFP 107) that are included in the image forming system 10 are communicably connected to each other via a network 135. It should be noted that in the present embodiment, the MFP 103, the MFP 104, and the PC 105 belong to a location 120, and the MFP 106 and the MFP 107 belong to a location 121. Here, the “location” refers to an arrangement location where the apparatus is arranged, or an affiliation to which the apparatus belongs, and the location is, for example, a business establishment of a company, or the like. In addition, in the present embodiment, the number of the apparatuses included in the image forming system 10 is four MFPs and one PC, but is not limited to this. The MFP is an image forming apparatus that has a printing function. It should be noted that the image forming apparatus is not limited to an MFP, and may be, for example, a single function printer (an SFP). The PC is an information processing apparatus. It should be noted that the information processing apparatus is not limited to a PC, and may be, for example, a tablet terminal, a smartphone, or the like. In addition, the number of locations to which the plurality of apparatuses included in the image forming system 10 are allocated is two in the present embodiment, but is not limited to this.

The management server 100 includes a printer database 101 and a user database 102 for managing information relating to the MFP 103, the MFP 104, the MFP 106, and the MFP 107. The printer database 101 stores MFP information relating to the MFP 103 or the like, for example, a device ID, location information, a printing function, and an operation status, of the MFP 103 or the like. The user database 102 stores, for example, a user ID, location information, MFP designation history information, etc. The user ID is a unique login ID for each user account that is used by a resident application (an application program) 111, which will be described below, to be connected to the management server 100. The location information is information about the location. In the present embodiment, an IP address is used as the location information, but the location information is not limited to an IP address, and may be, for example, a host name, a business establishment name, or information or the like obtained from a global positioning system (GPS) or the like. The MFP designation history information is a device ID of an MFP designated by the resident application 111. It should be noted that the management server 100 is capable of referring to the device ID stored in the printer database 101 by using the device ID, which is the MFP designation history information. For example, the management server 100 may start managing the MFP 103 to be managed in response to a registration request from the MFP 103. In addition, the management server 100 is also capable of performing the management of jobs.

The MFP 103, the MFP 104, the MFP 106, and the MFP 107 each manage the information relating to, for example, the location, the printing function, and the operation status, of the MFP. These pieces of information are provided to the management server 100.

A printer driver 110, the resident application 111, and a rendering application 112 are installed on the PC 105. The printer driver 110 is versatile software (a versatile program) that controls the execution of the printing function in the MFP 103 or the like. As a result, the PC 105 is capable of designating any one MFP of the MFP 103, the MFP 104, the MFP 106, and the MFP 107 as the destination of a print instruction. In addition, the printer driver 110 is used when performing a print setting in the rendering application 112. The resident application 111 is software that is automatically started up at the same time as an operating system (OS) of the PC 105 is started up, and that connects the PC 105 and the management server 100 via the network 135. In addition, the resident application 111 is capable of causing a CPU 150 (a computer) of the PC 105 to execute respective steps (a control method for the information processing apparatus), which will be described below. The rendering application 112 is software for, for example, creating documents, performing spreadsheets, and the like. The installation timing of the printer driver 110, the installation timing of the resident application 111, and the installation timing of the rendering application 112 may be the same or different.

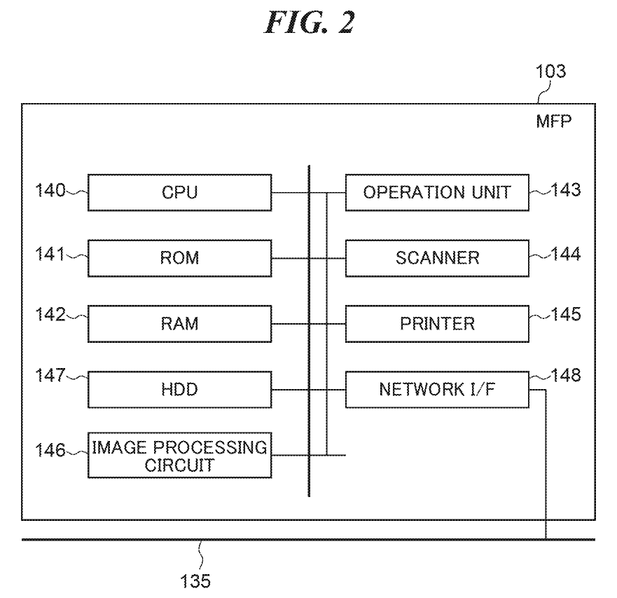

FIG. 2 is a block diagram that illustrates an example of a hardware configuration of the MFP. Since the MFP 103, the MFP 104, the MFP 106, and the MFP 107 have the same hardware configuration, the hardware configuration of the MFP 103 will be described as a representative example. As shown in FIG. 2, the MFP 103 includes a CPU 140, a read only memory (a ROM) 141, a random access memory (a RAM) 142, an operation unit 143, a scanner 144, a printer 145, an image processing circuit 146, a hard disk (an HDD) 147, and a network I/F 148. The CPU 140 is a computer that controls the operations of various kinds of devices (the ROM 141, etc.) based on control programs that have been stored in the ROM 141 or the HDD 147. The ROM 141 is a nonvolatile storage area, and stores the control programs and like that are executable by the CPU 140. The RAM 142 mainly functions as a main memory, a working area, and the like for the CPU 140. In addition, the RAM 142 may be configured so that its storage capacity is capable of being expanded by an optional RAM connected to an expansion port (not shown) of the MFP 103. The image processing circuit 146 performs various kinds of image processing with respect to arbitrary image data. The image processing is not particularly limited, and may be, for example, a conversion processing or the like for performing a print processing in the MFP 103. The HDD 147 is a nonvolatile storage area, and stores, for example, a boot program, various kinds of application programs, font data, user files, edit files, etc. The scanner 144 is a reading unit (a scanning unit) that reads (scans) a document and generates a read image ((a scanned image) of the document. The printer 145 is a printing unit that performs a printing operation based on predetermined image data. The operation unit 143 performs the display of a user interface (a UI) and the acceptance of inputting from a user via the UI. The network I/F 148 is an interface for performing data communication via the network 135. It should be noted that the MFP 103 may be connected to an external storage device, for example, an SD memory card, a flash memory, or the like.

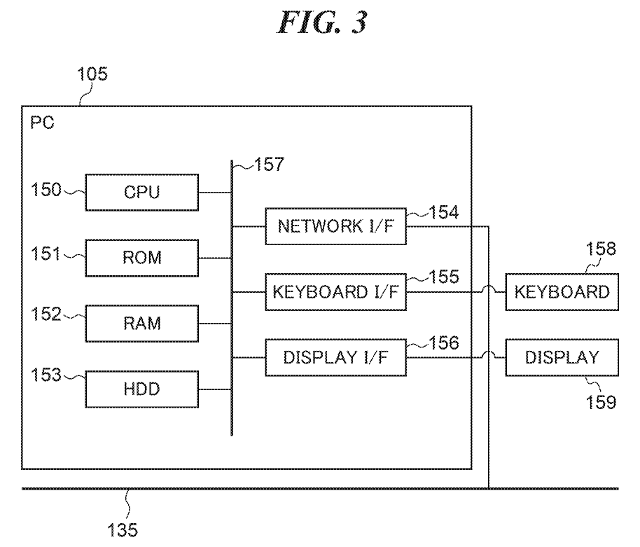

FIG. 3 is a block diagram that illustrates an example of a hardware configuration of the PC. As shown in FIG. 3, the PC 105 includes the CPU 150, a ROM 151, a RAM 152, an HDD 153, a network I/F 154, a keyboard I/F 155, and a display I/F 156, which are connected via a system bus 157 so as to be able to communicate with each other. The CPU 150 is the computer that controls the operations of various kinds of devices (the ROM 151, etc.) based on control programs that have been stored in the ROM 151 or the HDD 153. The ROM 151 stores the control programs and like that are executable by the CPU 150. The RAM 152 mainly functions as a main memory, a working area, and the like for the CPU 150. In addition, the RAM 152 may be configured so that its storage capacity is capable of being expanded by an optional RAM connected to an expansion port (not shown) of the PC 105. The HDD 153 stores, for example, a boot program, various kinds of application programs, font data, user files, edit files, etc. The network I/F 154 is an interface for performing data communication via the network 135. A keyboard 158 is connected to the keyboard I/F 155. As a result, it is possible to accept input instructions from the keyboard 158. A display 159 is connected to the display I/F 156. As a result, it is possible to display information such as an image on the display 159. It should be noted that the PC 105 may be connected to an external storage device, for example, an SD memory card, a flash memory, or the like.

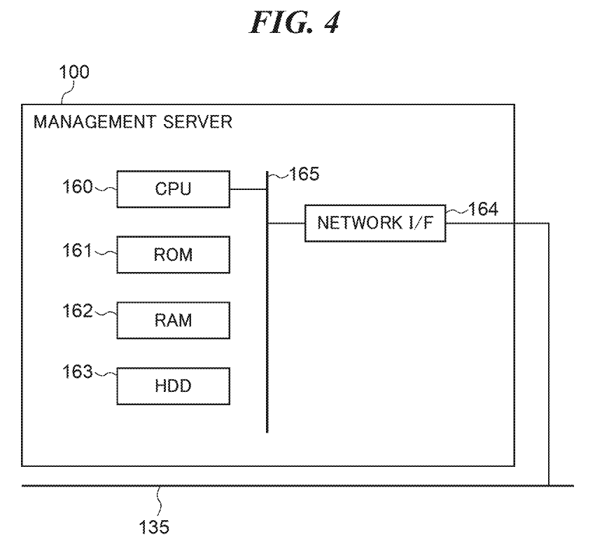

FIG. 4 is a block diagram that illustrates an example of a hardware configuration of the management server. As shown in FIG. 4, the management server 100 includes a CPU 160, a ROM 161, a RAM 162, an HDD 163, and a network I/F 164, which are connected via a system bus 165 so as to be able to communicate with each other. The CPU 160 is a computer that controls the operations of various kinds of devices (the ROM 161, etc.) based on control programs that have been stored in the ROM 161 or the HDD 163. The ROM 161 stores the control programs and like that are executable by the CPU 160. The RAM 162 mainly functions as a main memory, a working area, and the like for the CPU 160. In addition, the RAM 162 may be configured so that its storage capacity is capable of being expanded by an optional RAM connected to an expansion port (not shown) of the management server 100. The HDD 163 stores, for example, a boot program, various kinds of applications, font data, user files, edit files, etc. In addition, the HDD 163 stores, for example, the printer database 101 and the user database 102. The network I/F 164 is an interface for performing data communication via the network 135. It should be noted that the management server 100 may be connected to an external storage device, for example, an SD memory card, a flash memory, or the like.

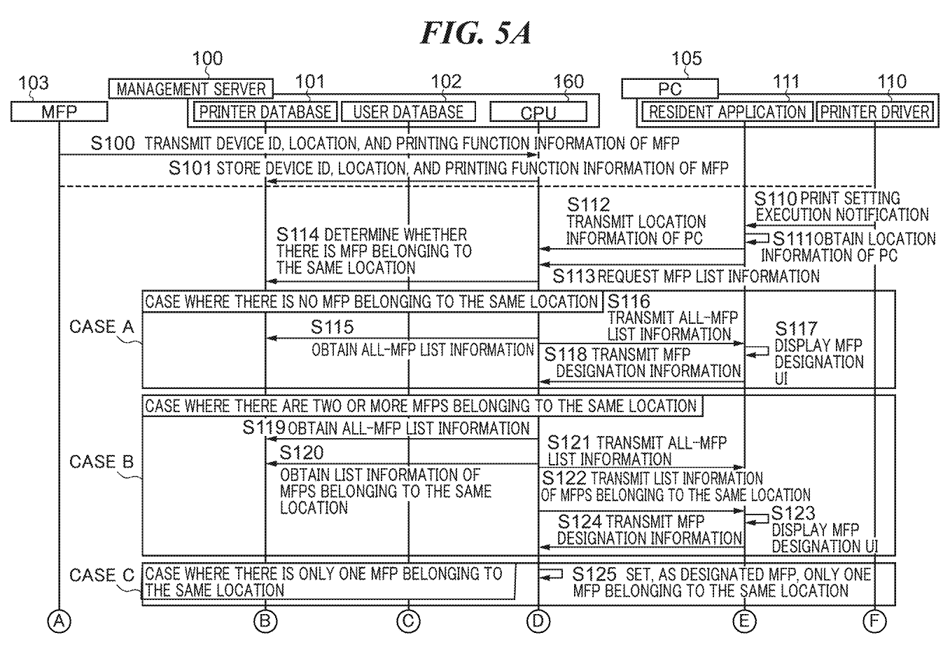

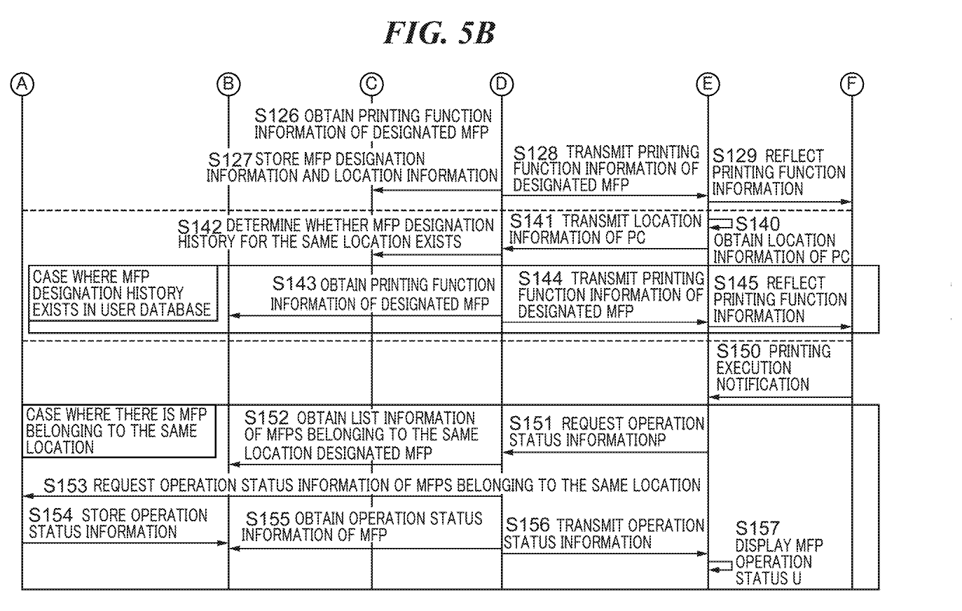

FIG. 5A and FIG. 5B are a sequence diagram that illustrates processing executed among the MFP, the management server, and the PC. In FIG. 5A and FIG. 5B, the MFP 103 is shown as a representative example among the MFP 103, the MFP 104, the MFP 106, and the MFP 107. In addition, transmitting and receiving information to and from the CPU 160 of the management server 100 are performed via the network 135 and the network I/F 164. As shown in FIG. 5A and FIG. 5B, in a step S100, the MFP 103 transmits the device ID, the location information, and printing function information of the MFP 103 to the management server 100. The process of the step S100 may be performed at regular time intervals, or may be performed when a predetermined event occurs. The predetermined event is not particularly limited, and examples thereof include new registration in the printer database 101, changing the location information, and changing the printing function information.

In a step S101, the CPU 160 of the management server 100 stores, in the printer database 101, the device ID, the location information, and the printing function information of the MFP 103 that have been transmitted in the step S100. It should be noted that in the case where the device ID, the location information, and the printing function information of the MFP 103 that have been transmitted in the step S100 have already been stored in the printer database 101, it is possible to omit the process of the step S100 and the process of the step S101.

In a step S110, in the case where a print setting has been executed, the printer driver 110 of the PC 105 transmits, to the resident application 111, a notification indicating that the print setting has been executed (a print setting execution notification).

In a step S111, the resident application 111 of the PC 105 obtains location information about the location 120 to which the PC 105 belongs (hereinafter, sometimes referred to as “location information of the PC 105”) from, for example, the HDD 153. The obtainment of the location information is performed, for example, by the resident application 111 requesting information about the IP address.

In a step S112, prior to a determining step that will be described below, the resident application 111 transmits the location information that has been obtained in the step S111 to the management server 100 (a transmitting step).

In a step S113, the resident application 111 requests the CPU 160 of the management server 100 for MFP list information (the MFP information) that has already been stored in the printer database 101 of the management server 100. It should be noted that the execution order of the process of the S112 and the process of the S113 may be reversed.

In a step S114, the CPU 160 of the management server 100 determines whether or not at least one MFP of the MFP 103, the MFP 104, the MFP 106, and the MFP 107 belongs to the location 120 of the PC 105. This determination is made based on whether or not MFP information for the MFPs belonging to the location 120 exists in the printer database 101, based on the location information about the location 120 and location information about the location to which each MFP belongs. Furthermore, the result of this determination is classified into, for example, three cases depending on the configuration of the image forming system 10. The first case is a determination result that “there is no MFP belonging to the location 120” (hereinafter, referred to as “a case A”). The second case is a determination result that “there are two or more MFPs belonging to the location 120” (hereinafter, referred to as “a case B”). The third case is a determination result that “there is only one MFP belonging to the location 120” (hereinafter, referred to as “a case C”). In the case A, processes of steps S115 to S118 are executed as the subsequent processing. In the case B, processes of steps S119 to S124 are executed as the subsequent processing. In the case C, a process of a step S125 is executed as the subsequent processing.

In the step S115 in the case A, the CPU 160 of the management server 100 obtains all-MFP list information from the printer database 101. The all-MFP list information is, for example, a list of all the MFPs to which the user of the PC 105 has access authority, from among the MFPs that have been registered on the management server 100. In the present embodiment, all the MFPs are the MFP 103, the MFP 104, the MFP 106, and the MFP 107. The all-MFP list information includes the device IDs of all the MFPs.

In the step S116, the CPU 160 transmits, to the resident application 111 of the PC 105, the all-MFP list information that has been obtained in the step S115.

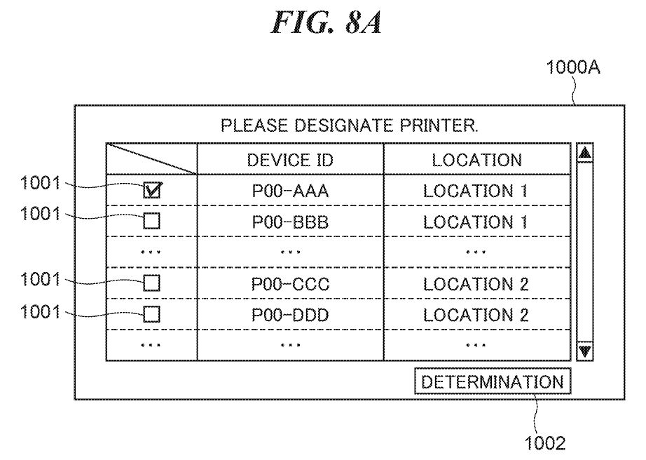

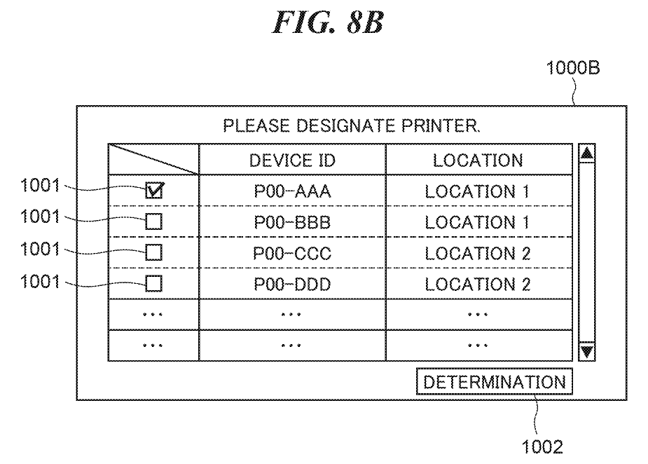

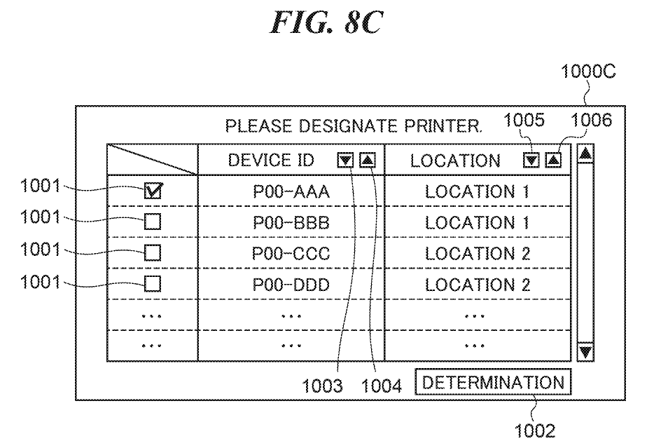

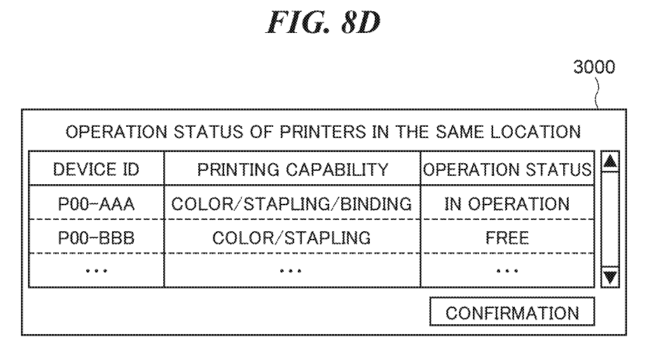

In the step S117, prior to a reflecting step that will be described below, the resident application 111 displays an MFP designation UI screen 1000B (see FIG. 8B) (a displaying step: a first displaying step).

In the step S118, the resident application 111 transmits, to the management server 100, information about an MFP that has been designated on the MFP designation UI screen 1000B displayed in the step S117 (MFP designation information). Then, based on this MFP designation information, the CPU 160 of the management server 100 sets the MFP that has been designated on the MFP designation UI screen 1000B as a designated MFP. The designated MFP is one MFP included in the MFP 103, the MFP 104, the MFP 106, and the MFP 107, which has been selected as a printing executing apparatus that causes to execute the printing function.

In the step S119 in the case B, as in the step S115, the CPU 160 of the management server 100 obtains all-MFP list information from the printer database 101.

In the step S120, the CPU 160 also obtains list information of the MFPs belonging to the location 120 from the printer database 101. In the present embodiment, the MFPs belonging to the location 120 are the MFP 103 and the MFP 104. The list information of the MFPs belonging to the location 120 includes the device IDs of the MFP 103 and the MFP 104. It should be noted that in the present embodiment, the all-MFP list information and the list information of the MFPs belonging to the location 120 have been obtained, respectively, but the present disclosure is not limited to this. For example, the MFPs within the all-MFP list information may be sorted in ascending order of the proximity of locations to each other, and the sorted data may be obtained. In addition, the execution order of the process of the S119 and the process of the S120 may be reversed.

In the step S121, the CPU 160 transmits, to the resident application 111 of the PC 105, the all-MFP list information that has been obtained in the step S119.

In the step S122, the CPU 160 transmits, to the resident application 111 of the PC 105, the list information of the MFPs belonging to the location 120 that has been obtained in the step S120. It should be noted that the execution order of the process of the S121 and the process of the S122 may be reversed.

In the step S123, prior to the reflecting step that will be described below, the resident application 111 displays an MFP designation UI screen 1000A (see FIG. 8A) (the displaying step: the first displaying step). On the MFP designation UI screen 1000A, the MFP 103 and the MFP 104 that belong to the location 120 are preferentially displayed at the top of the list.

In the step S124, the resident application 111 transmits, to the management server 100, information about an MFP that has been designated on the MFP designation UI screen 1000A displayed in the step S123 (MFP designation information). Then, based on this MFP designation information, the CPU 160 of the management server 100 sets the MFP that has been designated on the MFP designation UI screen 1000A as a designated MFP.

In the step S125 in the case C, the CPU 160 of the management server 100 sets only one MFP belonging to the location 120 as a designated MFP. It should be noted that in the case C, the display of an MFP designation UI has been omitted, but the present disclosure is not limited to this, and as in the case B, after obtaining the all-MFP list information, an MFP designation UI screen may be displayed on which only one MFP belonging to the location 120 is preferentially displayed at the top of the list.

In a step S126, the CPU 160 obtains, from the printer database 101, printing function information of the MFP that has been set as the designated MFP in any one of the steps S118, S124, and S125.

In a step S127, the CPU 160 stores, in the user database 102, the MFP designation information and the location information relating to the designated MFP. The MFP designation information is stored in an MFP designation history of the user database 102, for each location, and is used in the reflecting step using the MFP designation history, which will be described below.

In a step S128, the CPU 160 transmits, to the resident application 111, the printing function information of the designated MFP (the printing executing apparatus) that has been obtained in the step S126.

In a step S129, the resident application 111 of the PC 105 obtains, from the management server 100, the printing function information that has been transmitted in the step S128 (an obtaining step). Then, based on this printing function information, the resident application 111 reflects the printing function provided in the designated MFP in a function capable of being controlled by the printer driver 110 (the reflecting step).

Steps S140 to S145 are processes performed in the case where the function is reflected in the printer driver 110 based on the MFP designation history information that has been stored in the printer database 101. In the step S140, the resident application 111 of the PC 105 obtains the location information of the PC 105 from, for example, the HDD 153.

In the step S141, the resident application 111 transmits the location information that has been obtained in the step S140 to the management server 100.

In the step S142, the CPU 160 of the management server 100 determines whether or not the designated MFP belongs to the location 120 of the PC 105. This determination is made based on whether or not the MFP designation history of the designated MFP that belongs to the location 120 and that has been designated on the MFP designation UI screen exists in the printer database 101.

In the step S143, the CPU 160 obtains the printing function information of the designated MFP from the printer database 101.

In the step S144, the CPU 160 transmits the printing function information of the designated MFP that has been obtained in the step S143 to the resident application 111.

In the step S145, the resident application 111 of the PC 105 obtains, from the management server 100, the printing function information that has been transmitted in the step S144 (the obtaining step). In this way, in the obtaining step, the printing function information of the designated MFP included in the history that has been selected on the MFP designation UI screen is obtained as in the step S145, or the printing function information of the designated MFP that is being selected on the MFP designation UI screen is obtained as in the step S129. Then, based on the printing function information, the resident application 111 reflects the printing function provided in the designated MFP in a function capable of being controlled by the printer driver 110 (the reflecting step).

In addition, in the image forming system 10, for example, in the case where designating an MFP is the first time, the processes of the steps S110 to S129 are applied. Furthermore, in the case where designating an MFP is the second time or later, the processes of the steps S143 to S145 are applied. In addition, by reflecting the printing function that is based on the MFP designation history information, the user is able to cause the printer driver 110 to reflect the printing function without designating an MFP, but is also able to re-designate the designated MFP from the MFP designation UI screen of the resident application 111.

Steps S150 to S157 are processes for displaying the operation status of the MFP. In the step S150, the printer driver 110 of the PC 105 transmits a printing execution notification to the resident application 111.

In step the S151, the resident application 111 transmits, to the management server 100, a request for information about the operation status indicating whether the MFP is in operation or free (a request for operation status information).

In the step S152, the CPU 160 of the management server 100 obtains, from the printer database 101, list information of the MFPs belonging to the same location as the PC 105, that is, the list information of the MFPs belonging to the location 120. It should be noted that in the case where the list information of the MFPs belonging to the location 120 has already been obtained from the printer database 101 in the step S120, the process of the step S152 may be omitted.

In the step S153, the CPU 160 transmits, to the MFP 103, a request for operation status information of the MFPs belonging to the location 120 (an operation status information request), based on the MFP list information that has been obtained in the step S152 (the list information of the MFPs belonging to the location 120). It should be noted that as described above, in the case where the process of the step S152 has been omitted, in the step S153, the CPU 160 transmits, to the MFP 103, a request for operation status information of the MFPs belonging to the location 120 (an operation status information request), based on the MFP list information that has been obtained in the step S120 (the list information of the MFPs belonging to the location 120).

In the step S154, the MFP 103 stores, in the printer database 101, the operation status information of the MFP 103 at a time point when receiving the operation status information request that has been transmitted in the step S153. It should be noted that the MFP 103 may voluntarily store its own operation status information in the printer database 101 at a timing when the operation status of the MFP 103 has changed.

In the step S155, the CPU 160 of the management server 100 obtains, from the printer database 101, the operation status information that has been stored in the step S154.

In the step S156, the CPU 160 transmits, to the resident application 111, the operation status information that has been obtained in the step S155.

In the step S157, the resident application 111 of the PC 105 receives the operation status information that has been transmitted in the step S156. Then, the resident application 111 displays an MFP operation status UI 3000 (see FIG. 8D) that notifies the operation status of the MFP 103 based on the received operation status information (the displaying step: a second displaying step). The MFP operation status UI 3000 allows the user to confirm (check) the operation status of the MFP 103 and then instruct the execution of printing. For example, in the case where the MFP 103 is in operation, the user is able to cause to re-reflect the print setting with respect to another MFP that is not in operation (that is free) other than the MFP 103. It should be noted that although the MFP operation status UI 3000 is displayed on the display 159 of the PC 105, the present disclosure is not limited to this, and the MFP operation status UI 3000 may be displayed, for example, on the operation unit 143 of the MFP 103, or on both the display 159 and the operation unit 143.

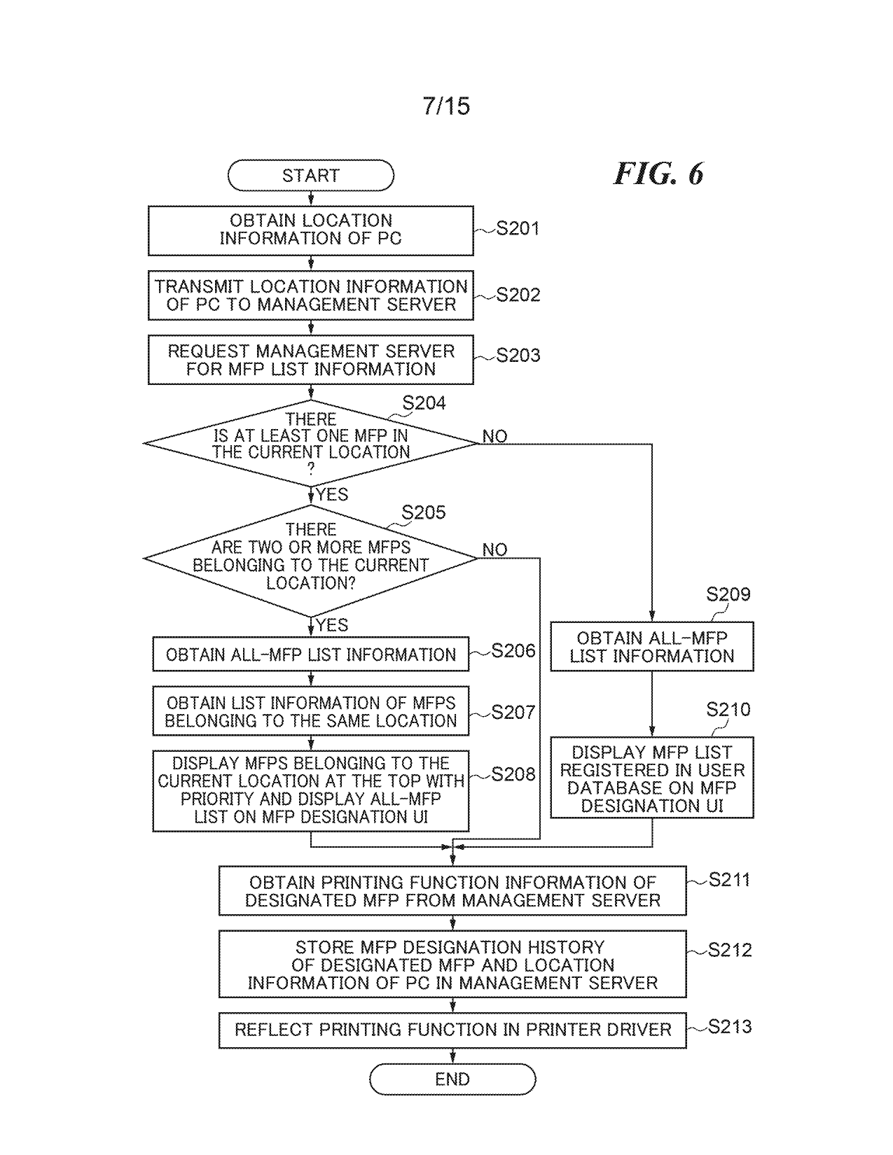

FIG. 6 is a flowchart that illustrates a processing executed by the resident application. A program based on the flowchart shown in FIG. 6 is started in the case where the resident application 111 has received the print setting execution notification (the step S110) from the printer driver 110. As shown in FIG. 6, in a step S201, as in the step S111, the resident application 111 obtains the location information of the PC 105.

In a step S202, as in the step S112, the resident application 111 transmits, to the management server 100, the location information that has been obtained in the step S201.

In a step S203, as in the step S113, the resident application 111 requests the management server 100 for the MFP list information that has already been stored in the printer database 101 of the management server 100.

In a step S204, the resident application 111 determines whether or not at least one MFP of the MFP 103, the MFP 104, the MFP 106, and the MFP 107 belongs to the location 120 of the PC 105 (the determining step). In the step S204, the result of the determination in the step S114 is used as the result of the determination in the determining step as it is. It should be noted that the resident application 111 may make this determination directly without using the result of the determination in the step S114. As the result of the determination in the step S204, in the case of being determined that at least one MFP of the MFP 103, the MFP 104, the MFP 106, and the MFP 107 belongs to the location 120 (YES in the step S204), the processing of FIG. 6 proceeds to a step S205. On the other hand, as the result of the determination in the step S204, in the case of being determined that there is no MFP belonging to the location 120 (NO in the step S204), the processing of FIG. 6 proceeds to a step S209.

In the step S205, the resident application 111 determines whether or not there are two or more MFPs belonging to the location 120. As the result of the determination in the step S205, in the case of being determined that there are two or more MFPs belonging to the location 120 (YES in the step S205), the processing of FIG. 6 proceeds to a step S206. On the other hand, as the result of the determination in the step S205, in the case of being determined that there are no two or more MFPs belonging to the location 120 (NO in the step S205), that is, in the case of being determined that there is one MFP belonging to the location 120, the processing of FIG. 6 proceeds to a step S211. In the case of being determined that there is one MFP belonging to the location 120, the resident application 111 is capable of determining that the designated MFP has been set.

In the step S206, the resident application 111 obtains the all-MFP list information (the step S121) from the management server 100.

In a step S207, the resident application 111 obtains the list information of the MFPs belonging to the location 120 (the step S122) from the management server 100.

In a step S208, as in the step S123, the resident application 111 displays the MFP designation UI screen 1000A (see FIG. 8A). On the MFP designation UI screen 1000A, all the MFPs (the MFP 103, the MFP 104, the MFP 106, and the MFP 107) that have been registered in the printer database 101 are displayed in a list. In addition, on the MFP designation UI screen 1000A, out of all the MFPs (the MFP 103, the MFP 104, the MFP 106, and the MFP 107) that have been registered in the printer database 101, the MFP 103 and the MFP 104 belonging to the location 120 are preferentially displayed at the top of the list.

In the step S209, the resident application 111 obtains the all-MFP list information (the step S116) from the management server 100.

In a step S210, as in the step S117, the resident application 111 displays the MFP designation UI screen 1000B (see FIG. 8B). Unlike the MFP designation UI screen 1000A, on the MFP designation UI screen 1000B, there is no MFP that is preferentially displayed.

In the step S211, the resident application 111 obtains the printing function information of the designated MFP (the step S128) from the management server 100.

In a step S212, the resident application 111 transmits the MFP designation history and the location information of the PC 105 to the management server 100.

In a step S213, as in the step S129, the resident application 111 reflects the printing function provided in the designated MFP in a function capable of being controlled by the printer driver 110.

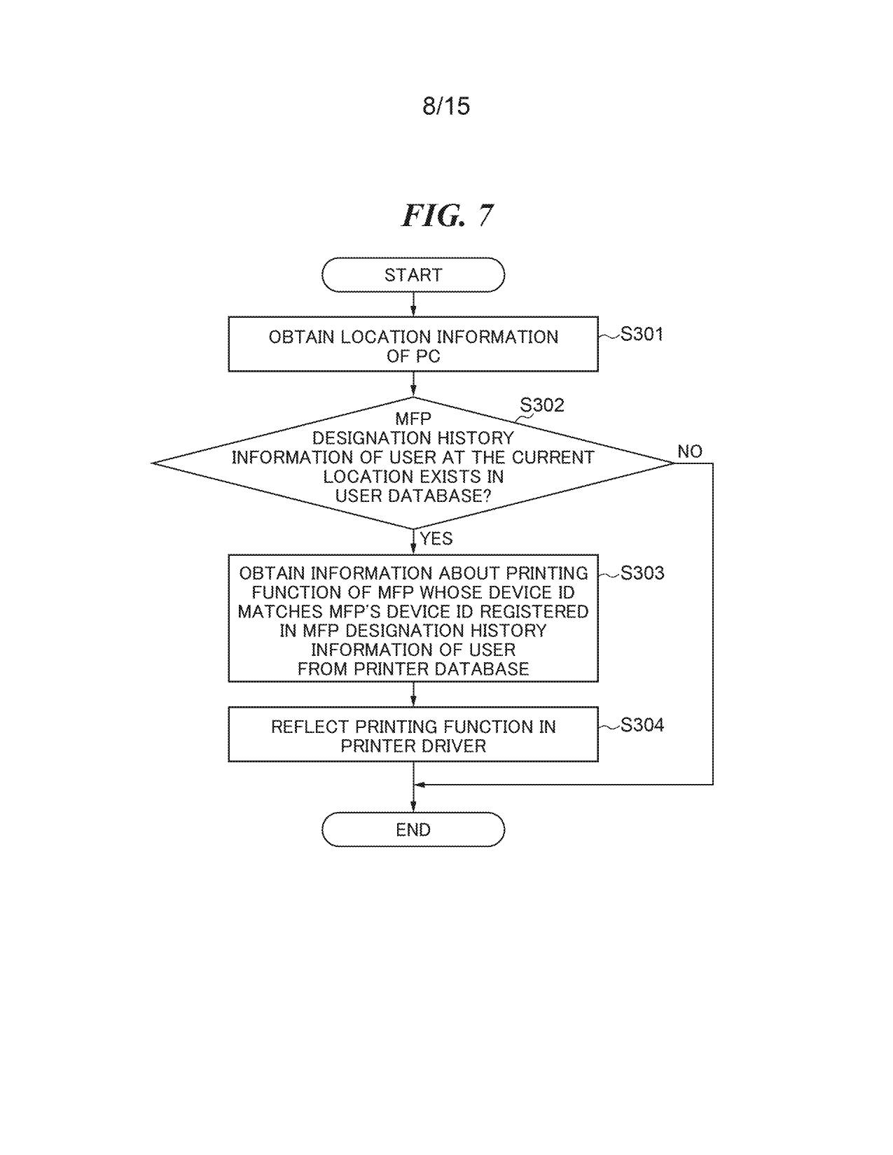

FIG. 7 is a flowchart that illustrates a detailed processing performed in the step S213 of the flowchart shown in FIG. 6. As shown in FIG. 7, in a step S301, the resident application 111 obtains the location information of the PC 105.

In a step S302, the resident application 111 determines whether or not there is the MFP designation history information of the user that matches the location information that has been obtained in the step S301 in the user database 102 of the management server 100. As the result of the determination in the step S302, in the case of being determined that there is the MFP designation history information of the user that matches the location information that has been obtained in the step S301 in the user database 102 (YES in the step S302), the processing of FIG. 7 proceeds to a step S303. On the other hand, as the result of the determination in the step S302, in the case of being determined that there is no MFP designation history information of the user that matches the location information that has been obtained in the step S301 in the user database 102 (NO in the step S302), the processing of FIG. 7 ends.

In the step S303, the resident application 111 obtains, from the printer database 101 of the management server 100, information about the printing function of the MFP whose device ID matches the device ID of the MFP, which has been registered in the MFP designation history information of the user.

In a step S304, based on the information about the printing function of the MFP, which has been obtained in the step S303, the resident application 111 reflects the printing function of the MFP in a function capable of being controlled by the printer driver 110.

FIG. 8A is a diagram that illustrates an example of a screen displayed by the resident application. It should be noted that in the following description, the device ID of the MFP 103 is “P00-AAA”, the device ID of the MFP 104 is “P00-BBB”, the device ID of the MFP 106 is “P00-CCC”, and the device ID of the MFP 107 is “P00-DDD”. The MFP designation UI screen 1000A shown in FIG. 8A is displayed in the step S123, and is an apparatus selection screen on which a designated MFP is capable of being selected. The MFP designation UI screen 1000A includes the MFPs with device IDs “P00-AAA” to “P00-DDD”. Furthermore, the MFPs (the MFP 103 and the MFP 104) from among these MFPs, which have been determined to belong to the location 120 as the result of the determination in the determining step, are displayed as designated MFPs so that they are capable of being selected preferentially, that is, are arranged at the top. On the other hand, the MFPs (the MFP 106 and the MFP 107), which have been determined not to belong to the location 120, are displayed as designated MFPs so that they are capable of being selected, but are arranged lower than the MFP 103 and the MFP 104 (are arranged at the bottom). As a result, the user is able to quickly designate, from among a plurality of MFPs, an MFP that belongs to the same location 120 as the PC 105 used by the user as the designated MFP. In addition, the MFP designation UI screen 1000A includes the name of the location to which each MFP belongs, a check box 1001 that is arranged corresponding to each MFP, and a button 1002. In the case of designating a designated MFP from among the plurality of MFPs, the user presses the button 1002 in a state where the check box 1001 of the MFP to be the designated MFP has been checked. As a result, the designated MFP is designated.

FIG. 8B is a diagram that illustrates an example of a screen displayed by the resident application. The MFP designation UI screen 1000B shown in FIG. 8B is displayed in the step S117 or the step S210, and is an apparatus selection screen on which a designated MFP is capable of being selected. Unlike the MFP designation UI screen 1000A, on the MFP designation UI screen 1000B, there is no MFP that is preferentially displayed. Therefore, for example, the MFP 103, the MFP 104, the MFP 106, and the MFP 107 are arranged from the top side toward the bottom side in ascending order of the device IDs, that is, in alphabetical order of the device IDs.

FIG. 8C is a diagram that illustrates a modification of the screen shown in FIG. 8B. An MFP designation UI screen 1000C shown in FIG. 8C includes buttons 1003 to 1006. By pressing the button 1003, the order of the device IDs is capable of being changed to ascending order, and by pressing the button 1004, the order of the device IDs is capable of being changed to descending order. In addition, by pressing the button 1005, the order of the locations is capable of being changed to ascending order, and by pressing the button 1006, the order of the locations is capable of being changed to descending order.

FIG. 8D is a diagram that illustrates an example of a screen displayed by the resident application. The MFP operation status UI 3000 shown in FIG. 8D is displayed in the step S157, and is a notification screen that notifies the user of the operation status of the MFP. The MFP operation status UI 3000 includes information about the operation statuses of the MFPs that have been determined to belong to the location 120. For example, the MFP 103 whose device ID is “P00-AAA” is displayed as “in operation (during the execution of printing)”, and the MFP 104 whose device ID is “P00-BBB” is displayed as “free (stopped)”. As a result, the user is able to select the MFP 104 from the MFP 103 and the MFP 104 to quickly obtain printed matter (printouts). In addition, the MFP operation status UI 3000 includes the printing function information of the MFPs that have been determined to belong to the location 120. For example, the MFP 103 whose device ID is “P00-AAA” is displayed as “color/stapling/binding”, and the MFP 104 whose device ID is “P00-BBB” is displayed as “color/stapling”. As a result, it is possible to prevent inconsistency from occurring between the print setting on the PC 105 and the printing function of the MFP as an output destination.

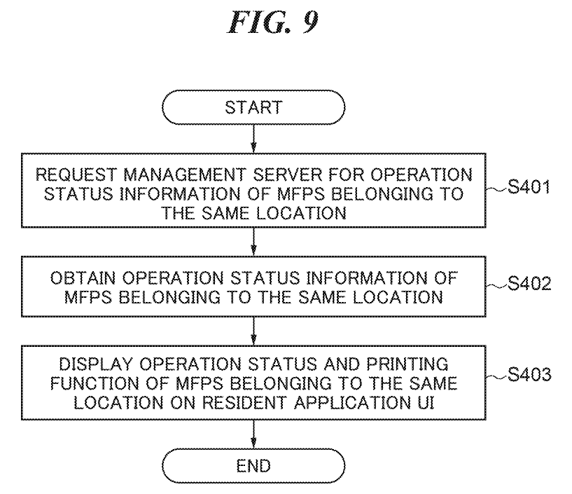

FIG. 9 is a flowchart that illustrates a processing (a notification screen display processing for notifying the operation status of the MFP) executed by the resident application. A program based on the flowchart shown in FIG. 9 is started in the case where the resident application 111 has received the printing execution notification from the printer driver 110 that has been invoked from the rendering application 112. As shown in FIG. 9, in a step S401, the resident application 111 requests the management server 100 for the operation statuses of the MFPs belonging to the location 120. In response to this request, the management server 100 transmits the operation statuses of the MFPs belonging to the location 120 to the resident application 111.

In a step S402, the resident application 111 obtains, from the management server 100, the operation statuses of the MFPs belonging to the location 120.

In a step S403, the resident application 111 displays, on the MFP operation status UI 3000, the operation statuses and the printing functions of the MFPs belonging to the location 120.

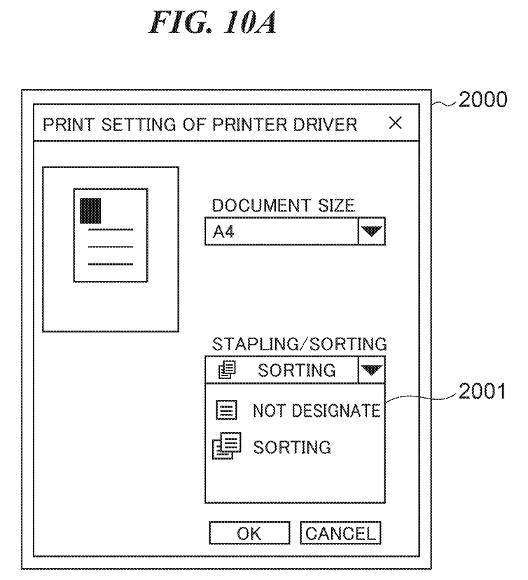

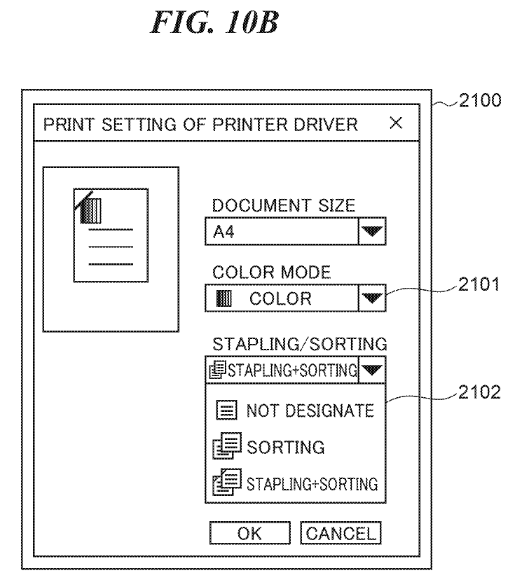

FIG. 10A and FIG. 10B are diagrams that illustrate examples of screens before and after a printing function reflection processing. FIG. 10A is a print setting UI screen of the printer driver 110 before the reflecting step of reflecting the printing function. FIG. 10B is a print setting UI screen of the printer driver 110 after the reflecting step of reflecting the printing function, that is, a screen on which a reflection result obtained in the reflecting step has been reflected. A print setting UI screen 2000 shown in FIG. 10A is a screen based on the printing function of an MFP that does not include a color function and a stapling function. On the print setting UI screen 2000, a color mode selection combo box is not displayed, and a stapling function is not capable of being selected in a stapling selection combo box 2001 either. Furthermore, in the case where the reflection result obtained in the reflecting step has been reflected, the print setting UI screen 2000 is changed to a print setting UI screen 2100 shown in FIG. 10B. Unlike the print setting UI screen 2000, the print setting UI screen 2100 allows the user to select the execution of the printing function provided in the designated MFP from a color mode selection combo box 2101 and a stapling selection combo box 2102. With the print setting UI screen 2000 and the print setting UI screen 2100, it is possible to execute the printing function provided in each MFP without causing excess or deficiency regardless of whether the location of the PC 105 is the same as the location of each MFP or not.

According to the present disclosure, it is possible to execute the printing function provided in each image forming apparatus without causing excess or deficiency regardless of whether the location of the information processing apparatus is the same as the location of each image forming apparatus or not.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-001664, filed January 6, 2025, which is hereby incorporated by reference herein in its entirety.

What is claimed is:

1. A non-transitory computer-readable storage medium storing an application program installed on an information processing apparatus communicably connected to a plurality of image forming apparatuses having a printing function and a management server that manages information about each of the image forming apparatuses, wherein
a printer driver that controls execution of the printing function in each of the image forming apparatuses has been installed on the information processing apparatus, and
the application program causes a computer of the information processing apparatus to execute
a determining step of determining whether or not at least one image forming apparatus from among the plurality of image forming apparatuses belongs to a location of the information processing apparatus; and
a reflecting step of selecting one image forming apparatus included in the plurality of image forming apparatuses as a printing executing apparatus that causes to execute the printing function, and reflecting the printing function provided in the printing executing apparatus in a function capable of being controlled by the printer driver.

2. The non-transitory computer-readable storage medium according to claim 1, wherein
the application program further causes the computer to execute a displaying step of, prior to the reflecting step, displaying an apparatus selection screen on which the printing executing apparatus is selected.

3. The non-transitory computer-readable storage medium according to claim 2, wherein
the application program further causes the computer to execute an obtaining step of obtaining, from the management server, printing function information about the printing function provided in the printing executing apparatus that is being selected on the apparatus selection screen or that is included in a history that has been selected on the apparatus selection screen.

4. The non-transitory computer-readable storage medium according to claim 3, wherein
in the reflecting step, based on the printing function information that has been obtained in the obtaining step, the printing function provided in the printing executing apparatus is reflected in the function capable of being controlled by the printer driver.

5. The non-transitory computer-readable storage medium according to claim 2, wherein
in the displaying step, as a result of the determination in the determining step, in a case of being determined that the at least one image forming apparatus belongs to the location, the image forming apparatus that has been determined to belong to the location is displayed on the apparatus selection screen so that it is capable of being preferentially selected as the printing executing apparatus, and in a case of being determined that the at least one image forming apparatus does not belong to the location, each of the image forming apparatuses is displayed on the apparatus selection screen so that it is capable of being selected as the printing executing apparatus.

6. The non-transitory computer-readable storage medium according to claim 5, wherein
on the apparatus selection screen in the case of being determined that the at least one image forming apparatus belongs to the location, the image forming apparatus that has been determined to belong to the location is arranged at a top, and the image forming apparatus that has not been determined to belong to the location is arranged at a bottom.

7. The non-transitory computer-readable storage medium according to claim 2, wherein
the application program further causes the computer to execute a second displaying step of, in a case where the displaying step is regarded as a first displaying step, displaying a notification screen that notifies an operation status of the image forming apparatus that has been determined to belong to the location.

8. The non-transitory computer-readable storage medium according to claim 7, wherein
the notification screen includes printing function information about the printing function of the image forming apparatus that has been determined to belong to the location.

9. The non-transitory computer-readable storage medium according to claim 1, wherein
in the reflecting step, a reflection result obtained in the reflecting step is displayed as a screen, and the screen is configured to allow to select execution of the printing function provided in the printing executing apparatus, which has been reflected as the function capable of being controlled by the printer driver.

10. The non-transitory computer-readable storage medium according to claim 1, wherein
the application program further causes the computer to execute a transmitting step of, prior to the determining step, transmitting, to the management server, location information about the location to which the information processing apparatus belongs.

11. The non-transitory computer-readable storage medium according to claim 10, wherein
the management server determines whether or not at least one image forming apparatus from among the plurality of image forming apparatuses belongs to the location to which the information processing apparatus belongs, based on the location information about the location to which the information processing apparatus belongs and location information about a location to which each of the image forming apparatuses belongs, and a result of the determination made by the management server is used as a result of the determination in the determining step as it is.

12. A control method for controlling an information processing apparatus communicably connected to a plurality of image forming apparatuses having a printing function and a management server that manages information about each of the image forming apparatuses, wherein
a printer driver that controls execution of the printing function in each of the image forming apparatuses has been installed on the information processing apparatus, and
the control method for the information processing apparatus comprises
a determining step of determining whether or not at least one image forming apparatus from among the plurality of image forming apparatuses belongs to a location of the information processing apparatus; and
a reflecting step of selecting one image forming apparatus included in the plurality of image forming apparatuses as a printing executing apparatus that causes to execute the printing function, and reflecting the printing function provided in the printing executing apparatus in a function capable of being controlled by the printer driver.

13. An information processing apparatus communicably connected to a plurality of image forming apparatuses having a printing function and a management server that manages information about each of the image forming apparatuses, wherein
a printer driver that controls execution of the printing function in each of the image forming apparatuses, and an application program have been installed on the information processing apparatus, and
the application program causes a computer of the information processing apparatus to execute
a determining step of determining whether or not at least one image forming apparatus from among the plurality of image forming apparatuses belongs to a location of the information processing apparatus; and
a reflecting step of selecting one image forming apparatus included in the plurality of image forming apparatuses as a printing executing apparatus that causes to execute the printing function, and reflecting the printing function provided in the printing executing apparatus in a function capable of being controlled by the printer driver.
